(19) United States
(12) Patent Application Publication
(10) Pub. No.: US 2016/0035257 A1
(43) Pub. Date: Feb. 4, 2016

(54) BANNER DISPLAY SYSTEM FOR ATTACHMENT TO AN AUTOMOBILE

(71) Applicant: CHARLES ANDERSON LIKAS, Belvedere, CA (US)

(72) Inventor: CHARLES ANDERSON LIKAS, Belvedere, CA (US)

(21) Appl. No.: 14/450,904

(22) Filed: Aug. 4, 2014

(51) Int. Cl. G09F 17/00; G09F 21/04

(52) U.S. Cl. CPC G09F 17/00; G09F 21/04

(57) ABSTRACT

Some embodiments of the present disclosure include a banner display system for displaying a banner lengthwise over an automobile. In some embodiments, the banner display system may include a first clamp assembly and a second clamp assembly, each clamp assembly including a C-clamp and a pole slot, and each clamp assembly configured to removably attach to an automobile, a first pole extending upwardly from the pole slot in the first clamp assembly; and a second pole extending upwardly from the pole slot in the second clamp assembly. A banner may be secured to each of the first pole and the second pole, resulting in the banner being displayed lengthwise over the automobile. In embodiments, the poles may be made of a bendable material, such that the banner is able to gently move without damaging the display assembly or the vehicle.

### BACKGROUND

The embodiments herein relate generally to marketing accessories, and more particularly, to a banner display system configured to attach to an automobile.

Many people and companies use display banners to grab the attention of passers-by. However, it can be difficult to find a suitable place to display large banners. Sometimes, people will attach the banners to trees or other stationary objects, but these objects may not be located in the most desirable position. While it may be desirable to attach a banner to an automobile, conventionally there is no device available to display a large banner lengthwise above an automobile.

Therefore, what is needed is a system for displaying a banner, wherein the system is configured to attach to an automobile, thus making the display system mobile.

### SUMMARY

Some embodiments of the present disclosure include a banner display system for displaying a banner lengthwise over an automobile. In some embodiments, the banner display system may include a first clamp assembly and a second clamp assembly, each clamp assembly including a C-clamp and a pole slot, and each clamp assembly configured to removably attach to an automobile, a first pole extending upwardly from the pole slot in the first clamp assembly; and a second pole extending upwardly from the pole slot in the second clamp assembly. A banner may be secured to each of the first pole and the second pole, resulting in the banner being displayed lengthwise over the automobile. In embodiments, the poles may be made of a bendable material, such that the banner is able to gently move without damaging the display assembly or the vehicle.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present invention, shown in use.

FIG. 2 is a perspective view of one embodiment of the present invention.

FIG. 3 is a detail exploded view of one embodiment of the present invention.

FIG. 4 is a section view of one embodiment of the present invention, taken along line 4-4 in FIG. 2.

FIG. 5 is a schematic view of one embodiment of the present invention, illustrating the placement of the banner display system onto an automobile.

FIG. 6 is an exploded view of one embodiment of the present invention.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used to display a banner lengthwise over an automobile and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.
1. Clamp Assemblies
2. Poles
3. Banner Fasteners
4. Banner

The various elements of the banner display system for attaching a banner to and displaying a banner lengthwise over an automobile of the present disclosure may be related in the following exemplary fashion. It is not intended to limit the scope or nature of the relationships between the various elements and the following examples are presented as illustrative examples only.

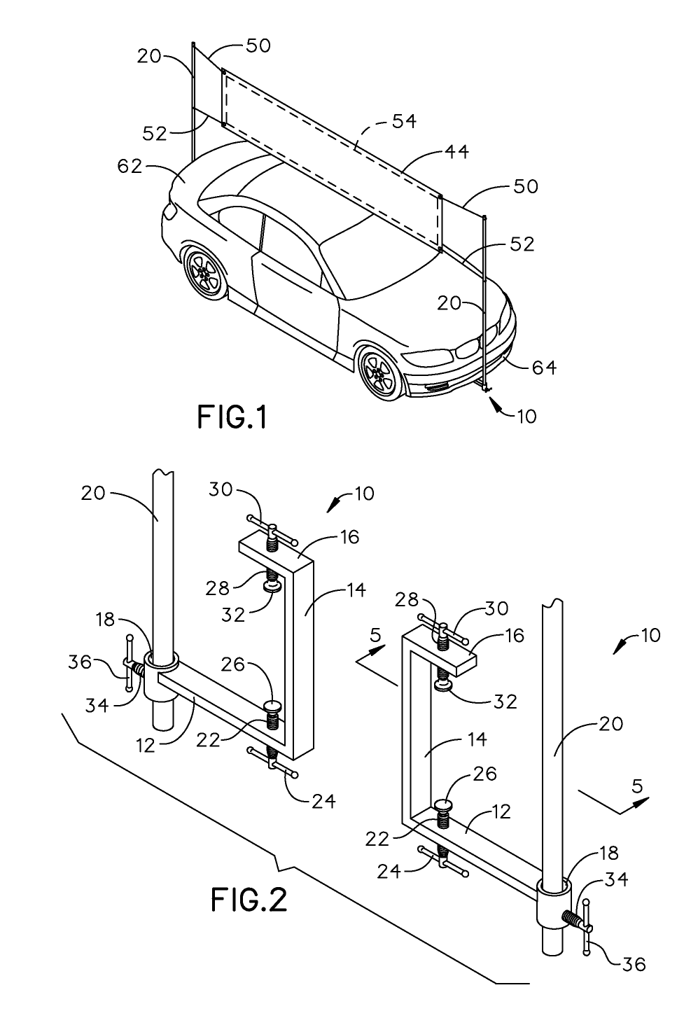

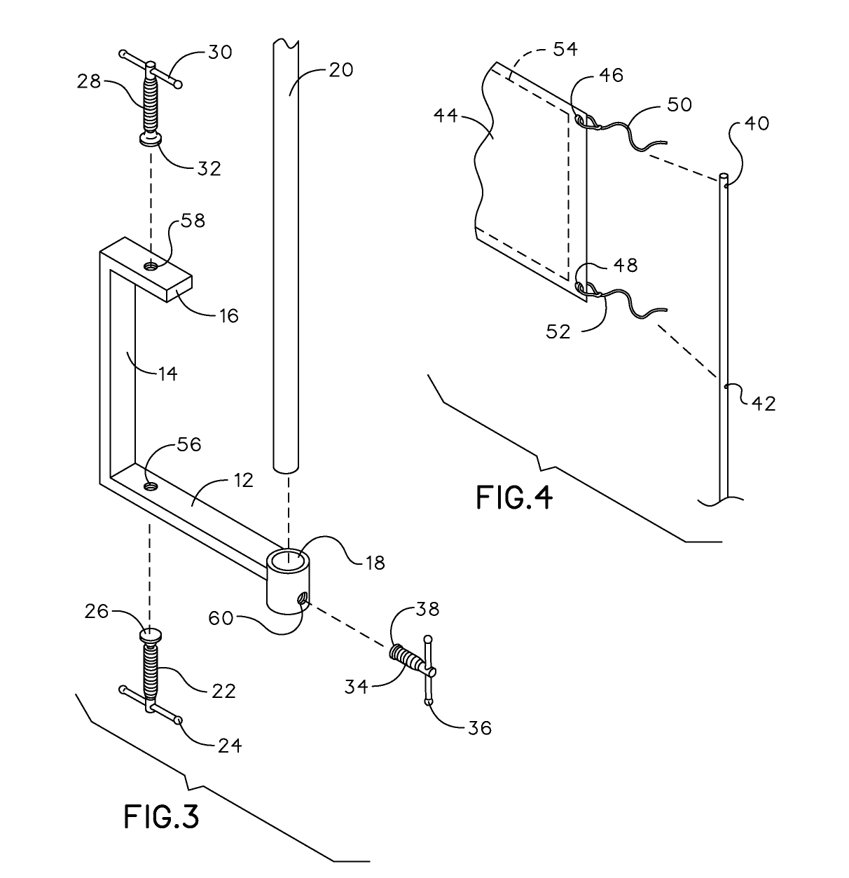

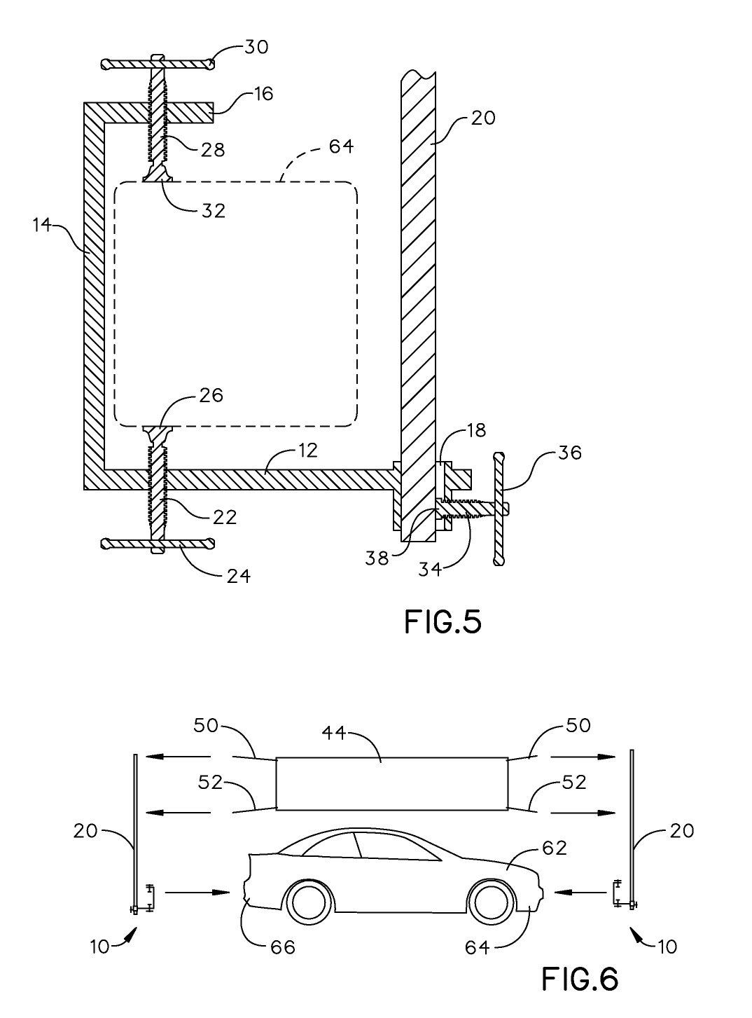

By way of example, and referring to FIGS. 1-5, some embodiments of the banner display system of the present disclosure comprise a first clamp assembly 10 and a second clamp assembly 10 configured to attach to an automobile 62, a first clamp assembly 10 configured to attach to the front bumper 64 and the second clamp assembly 10 configured to attach to the rear bumper 66, a first pole 20 extending upwardly from the first clamp assembly 10 and a second pole 20 extending upwardly from the second clamp assembly 10, wherein a banner 44 having a banner display area 54 may be attached to each of the poles 20 using a fastener. In some embodiments, the fastener may comprise an upper banner tie 50 and a lower banner tie 52 attaching a first end of the banner 44 to the first pole 20 and a second end of the banner 44 to the second pole 20.

As shown in FIGS. 2, 3, and 5, each clamp assembly 10 may comprise a clamp, such as a C-clamp, configured to support a pole 20 and attach to a bumper 64, 66, resulting in a banner 44 being displayed lengthwise above an automobile 62. In some embodiments, the clamp assembly 10 may comprise a C-clamp comprising a pole slot 18 configured to accept a pole 20, wherein the pole 20 may be secured within the pole slot 18 using a pole clamp post 34 comprising a pole clamp handle 36 and a pole clamp foot 38, wherein a user may secure the pole 20 into the pole slot 18 by twisting the pole clamp handle 36, causing the pole clamp foot 38 to tighten against the pole 20. A lower clamp bar 12 may extend outwardly from the pole slot 18, such that the lower clamp bar 12 is substantially perpendicular to the pole 20. An upright clamp bar 14 may extend upwardly from the lower clamp bar 12, such that the upright clamp bar 14 is substantially perpendicular to the lower clamp bar 12 and substantially parallel to the pole 20. An upper clamp bar 16 may extend perpendicularly towards the pole 20 from an upper most end of the upright clamp bar 14, such that the upper clamp bar 16 is substantially perpendicular to the upright clamp bar 14 and the pole 20 and substantially parallel to the lower clamp bar 12.

The lower clamp bar 12 may comprise a lower clamp post 22 extending through a lower clamp hole 56 in the lower clamp bar 12, wherein the lower clamp post 22 comprises a lower clamp foot 26 and a lower clamp handle 24, and the lower clamp foot 26 is configured to apply pressure to a lower surface of a bumper 64, 66 when a user rotates the lower clamp handle 24. Similarly, the upper clamp bar 16 may comprise an upper clamp post 28 extending through an upper clamp hole 58 in the upper clamp bar 16, wherein the upper clamp post 28 comprises an upper clamp foot 32 and an upper clamp handle 30, and the upper clamp foot 32 is configured to apply pressure to an upper surface of a bumper 64, 66 when a user rotates the upper clamp handle 30. Thus, the banner display system may comprise a pair of clamp assemblies 10 configured to removably attach to the bumpers 64, 66 of a vehicle by tightening a lower clamp post 22 and an upper clamp post 28, securing the assemblies 10 to the bumpers 64, 66.

As described above, the poles 20 may extend vertically upwards from the pole slot 18 in the clamp assemblies 10. A banner 44, such as a banner 44 having a banner display area 54, may be attached to the poles 20 using a fastener. For example, in some embodiments, the fastener may comprise an upper banner tie 50 and a lower banner tie 52 attached to each end of the banner 44, such as being tied or otherwise secured to an upper banner hole 46 and a lower banner hole 48, respectively, wherein each of the upper banner tie 50 and the lower banner tie 48 are secured to the pole 20, such as by tying or otherwise securing the upper banner tie 50 and the lower banner tie 48 to upper pole hole 40 and lower pole hole 42, respectively. The ties 48, 50 may be tightened, as necessary, to pull the banner 44 taut lengthwise above the car, as shown in FIG. 1.

The banner display system of the present disclosure may have any desired size and may be made of any desired material. In some embodiments, the clamp assemblies 10 may be made of a thick plastic and/or metal, and the poles 20 may comprise a fiber glass material, carbon fiber, a glass fiber composite, a silicon material, or another bendable yet rigid material, similar to that used to make a fishing pole. When the poles 20 are bendable or flexible, rather than rigid, the poles may allow the banner 44 to move gently without damaging the banner display system. In some embodiments, the portion of the pole 20 nearest to the automobile, such as the lowest third of the pole 20, may comprise a protective coating, such as a rubber coating, or may be made of a rubber material to prevent the pole 20 from scratching the automobile. Moreover, the pole 20 may extend in a telescoping like fashion such that the pole is self collapsing. For example, the top third of the pole 20 may collapse into the middle third of the pole 20, which may collapse into the bottom third of the pole 20. To use a telescoping pole 20, a user would simply pull on the top portion of the pole to telescopically extend the pole 20. In embodiments, the banner 44 to be attached to the banner display system may have any desired dimensions and, for example, may be from about 8 to about 10 feet long and from about 2 to about 4 feet tall

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A banner display system for displaying a banner lengthwise over an automobile, the banner display system comprising:
a first clamp assembly and a second clamp assembly, each clamp assembly configured to removably attach to an automobile;
a first pole extending upwardly from the first clamp assembly; and
a second pole extending upwardly from the second clamp assembly, wherein:
a banner may be secured to each of the first pole and the second pole, resulting in the banner being displayed lengthwise over the automobile.

2. The banner display system of claim 1, wherein:
the first clamp assembly is configured to attach to a front bumper of the vehicle; and
the second clamp assembly is configured to attach to a rear bumper of the vehicle.

3. The banner display system of claim 1, wherein:
each of the first clamp assembly and the second clamp assembly comprises a C-clamp configured to attach to a bumper of a vehicle, the C-clamp comprising a pole slot configured to accept a pole, the pole slot comprising a pole clamp post configured to secure the pole within the pole slot; and
the pole clamp post comprises a pole clamp handle and a pole clamp foot, the pole clamp foot being configured to apply pressure to the pole, securing the pole within the pole slot.

4. The banner display system of claim 3, wherein each of the first clamp assembly and the second clamp assembly further comprises:
a lower clamp bar extending outwardly from the pole slot, such that the lower clamp bar is substantially perpendicular to the pole extending from the pole slot;
an upright clamp bar extending upwardly from the lower clamp bar, such that the upright clamp bar is substantially perpendicular to the lower clamp bar and substantially parallel to the pole; and
an upper clamp bar extending perpendicularly towards the pole from an upper most end of the upright clamp bar, such that the upper clamp bar is substantially perpendicular to the upright clamp bar and the pole and is substantially parallel to the lower clamp bar.

5. The banner display system of claim 4, wherein the clamp assembly further comprises:
a lower clamp post configured to extending through a lower clamp hole in the lower clamp bar, wherein the lower clamp post comprises a lower clamp foot and a lower clamp handle, the lower clamp foot being to apply pressure to a lower surface of the bumper to which the clamp assembly is removably attached; and
an upper clamp post configured to extend through an upper clamp hole in the upper clamp bar, wherein the upper clamp post comprises an upper clamp foot and an upper clamp handle, the upper clamp foot being configured to apply pressure to an upper surface of the bumper to which the clamp assembly is removable attached.

6. The banner display system of claim 1, further comprising a fastener for removably and adjustable connecting the banner to the first pole and the second pole.

7. The banner display system of claim 6, wherein the fastener comprises an upper banner tie and a lower banner tie attached to each end of the banner, wherein each of the upper banner tie and the lower banner tie are secured to the pole by tying the upper banner tie and the lower banner tie to an upper pole hole and s lower pole hole, respectively.

8. The banner display system of claim 1, wherein each of the first pole and the second pole are made of a material selected from the group consisting of a fiber glass material, carbon fiber, a glass fiber composite, and a silicon material.

9. A banner display system for displaying a banner lengthwise above an automobile, the banner display system comprising:
a first clamp assembly configured to removably attach to a bumper of an automobile, the first clamp assembly comprising:
a pole slot configured to accept a pole;
a lower clamp bar extending outwardly from the pole slot, such that the lower clamp bar is substantially perpendicular to the pole slot;
an upright clamp bar extending upwardly from the lower clamp bar, such that the upright clamp bar is substantially perpendicular to the lower clamp bar and substantially parallel to the pole slot; and
an upper clamp bar extending perpendicularly towards the pole slot from an upper most end of the upright clamp bar, such that the upper clamp bar is substantially perpendicular to the upright clamp bar and the pole slot and is substantially parallel to the lower clamp bar;
a first bendable pole extending upwardly from the first clamp assembly; and
a first fastener for securing a banner to the first pole.

10. The banner display system of claim 9, further comprising:
a second clamp assembly configured to removably attach to a bumper of an automobile, the second clamp assembly comprising:
a pole slot configured to accept a pole;
a lower clamp bar extending outwardly from the pole slot, such that the lower clamp bar is substantially perpendicular to the pole slot;
an upright clamp bar extending upwardly from the lower clamp bar, such that the upright clamp bar is substantially perpendicular to the lower clamp bar and substantially parallel to the pole slot; and
an upper clamp bar extending perpendicularly towards the pole slot from an upper most end of the upright clamp bar, such that the upper clamp bar is substantially perpendicular to the upright clamp bar and the pole slot and is substantially parallel to the lower clamp bar;
a second bendable pole extending upwardly from the first clamp assembly; and
a second fastener for securing a banner to the second pole,
wherein:
each of the first fastener and the second fastener comprise an upper banner tie and a lower banner tie attached to each end of the banner, wherein each of the upper banner tie and the lower banner tie are secured to their respective pole by tying the upper banner tie and the lower banner tie to an upper pole hole and s lower pole hole, respectively.
